(19) United States
(12) Patent Application Publication
(10) Pub. No.: US 2008/0187259 A1
(43) Pub. Date: Aug. 7, 2008

(54) SLIDING BEARING

(75) Inventors: Osamu ISHIGO, Inuyama (JP); Takahito Nakagawa, Inuyama (JP); Kouji Kuroda, Inuyama (JP); Akira Ono, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: Daido Metal Co., Ltd., Naka-Ku (JP)

(21) Appl. No.: 11/861,605

(22) Filed: Sep. 26, 2007

(30) Foreign Application Priority Data
Sep. 26, 2006 (JP) 2006-259855

(51) Int. Cl. F16C 9/02

(52) U.S. Cl. 384/294

(57) ABSTRACT

Disclosed is a cylindrical sliding bearing consisting of an upper and a lower half bearings, which supports a crankshaft of an internal combustion engine. An oil groove is formed circumferentially on an inner surface of at least the upper half bearing. There are provided circumferential grooves formed by boring machining on the overall inner surfaces of the half bearings. Each of the circumferential grooves existing in circumferential both end regions has a larger cross-sectional area than the grooves existing in other regions receiving predominantly operational load when the crankshaft rotates. The upper half bearing is chamfered at a front inner end edge with respect to a rotational direction of the crankshaft supported by the sliding bearing, and the lower half bearing is also chamfered at an inner end edge adjacent to the above front inner end edge, an area of the respective chamfered portion being the same as the 0.15 mm to 0.4 mm length chamfer corner area.

### TECHNICAL FIELD

The present invention relates to a sliding bearing which is fabricated cylindrically with a pair of upper and lower half bearings so as to support a crankshaft of an internal combustion engine, wherein an oil groove is formed circumferentially on an inner surface of at least the upper half bearing, and wherein there are provided a plurality of circumferential grooves formed by boring machining on the overall inner surfaces of the half bearings, each of the plurality of grooves existing in circumferential both end regions having a larger cross-sectional area than the grooves existing in other regions receiving predominantly operational load when the crankshaft rotates.

Recently improvement of exhaust gases, fuel cost saving and so on have been strongly required in automobile industries because of globally progressing environmental problems. In order to meet such requirements, the present inventors proposed previously a technique aiming at an increase in a fuel efficiency by decreasing oil leaks from bearings, as disclosed in JP-A-2002-188624 (herein below referred to as “Patent Document 1”). The technique disclosed in Patent Document 1 relates to half bearings each of which inner surface is provided with circumferential grooves formed by boring machining, wherein each of the grooves existing in circumferential both end regions has a larger depth than each of the grooves having a smaller depth and existing in the other region receiving predominantly operational load when a shaft rotates whereby making the former grooves in the circumferential both end regions to have a larger cross-sectional area, respectively, than each of the latter grooves existing in the other region (herein below, the technique is referred to as “multi-boring machining”). According to such grooves, ridges defining the deeper grooves in the circumferential end regions wear in an early operational stage to conform with the mating shaft whereby the thus worn regions serve as crash relieves thereby enabling decrease of an oil leak from the bearing and also of an oil supply quantity.

The technique disclosed in Patent Document 1 has excellent advantageous effects of prevention of the oil leak and saving the quantity of oil supply to bearings, but it is silent on discharge of foreign particles entrained in the bearings. Especially under severe operational environments for the bearing in these days, foreign particles remaining in the bearings often cause the bearings not to well work in a short period of time.

The present invention was achieved under the above background.

An object of the invention is to provide a sliding bearing, which can effectively discharges foreign particles while maintaining advantages of the sliding bearing produced by multi-boring machining, which advantages fire capabilities of prevention of oil leaks from the bearing and reduction of oil supply to the bearing.

### BRIEF SUMMARY OF THE INVENTION

Under such an object, according to the present invention, there is provided a sliding bearing which is fabricated cylindrically with a pair of upper and lower half bearings so as to support a crankshaft of an internal combustion engine,

wherein an oil groove is formed, circumferentially on an inner surface of at least the upper half bearing,

wherein there are provided a plurality of circumferential grooves formed by boring machining on the overall inner surfaces of the half bearings, each of the plurality of circumferential grooves existing in circumferential both end regions having a larger cross-sectional area than the grooves existing in other regions receiving predominantly operational load when the crankshaft rotates, and

wherein the upper half bearing is chamfered at a front inner end edge with respect to a rotational direction of the crankshaft supported by the sliding bearing, and the lower half bearing is also chamfered at an inner end edge adjacent to the above front inner end edge of the upper half bearing, a cross or transversal sectional area, perpendicular to the axis of the sliding bearing, of the respective spatial portion formed by chamfering being the same as a chamfered cross or transversal sectional area, perpendicular to the axis of the sliding bearing, of a chamfer corner with a right-angled triangle having an isosceles length of from 0.15 mm to 0.4 mm. Hereafter the chamfered cross sectional area defined by the right-angled triangle having an isosceles length of 0.15 mm or 0.4 mm is only referred to as the 0.15 mm length chamfer corner area or the 0.4 mm length chamfer corner area.

According to the invention, oil leaks occur through the chamfered portions at butting faces of the upper and lower half bearings, whereby an oil flow rate near the butting faces become relatively higher according to a supposition, so that it is possible to promptly discharge foreign particles, which flow through the oil groove to the chamfered portions, to the outside the sliding bearing.

If the chamfered portion has a cross sectional area smaller than area being the same as the 0.15 mm length chamfer corner area, it is impossible to obtain an enough effect of discharging the foreign particles and a back surface of the sliding bearing rises in temperature. If the chamfered portion has a cross sectional area exceeding an area of the same as the 0.4 mm length chamfer corner area, there will occur a much amount of oil leaks. Taking such disadvantages into consideration, a size of the chamfered portion is set to the same area as the 0.15 mm to 0.4 mm length chamfer corner area, preferably the 0.2 mm to 0.4 mm length chamfer corner area.

### BRIEF DESCRIPTION OF THE SEVERAL VIEWS OF THE DRAWINGS

FIG. 1A is a side view of a sliding bearing consisting of a pair of an upper and a lower half bearings which support a crankshaft;

FIG. 1B is an inside view of the upper and the lower half bearings;

FIG. 2 is a schematic view illustrating a relationship between an axial oil passage formed in the crankshaft and a communicating oil passage leading to a connecting rod pin;

FIG. 3 is an enlarged view for explaining a foreign-particles discharge mechanism at chamfered portions;

FIG. 4A is a side view illustrating a structure of an inner surface of the upper or lower half bearing;

FIG. 4B is a sectional view illustrating the above structure of the upper or lower half bearing at a circumferential central region;

FIG. 4C is a sectional view illustrating the above structure of the upper or lower half bearing at a circumferential end region; and

FIG. 5 is a graph showing test results of Invention Sliding Bearings (produced by the multi-boring machining) and Comparative Sliding Bearings (produced by usual boring machining) being provided with circumferential shallow grooves on an inner surface thereof, crash-relieves at both ends thereof, and chamfered portions at inner end edges thereof.

### DETAILED DESCRIPTION OF THE INVENTION

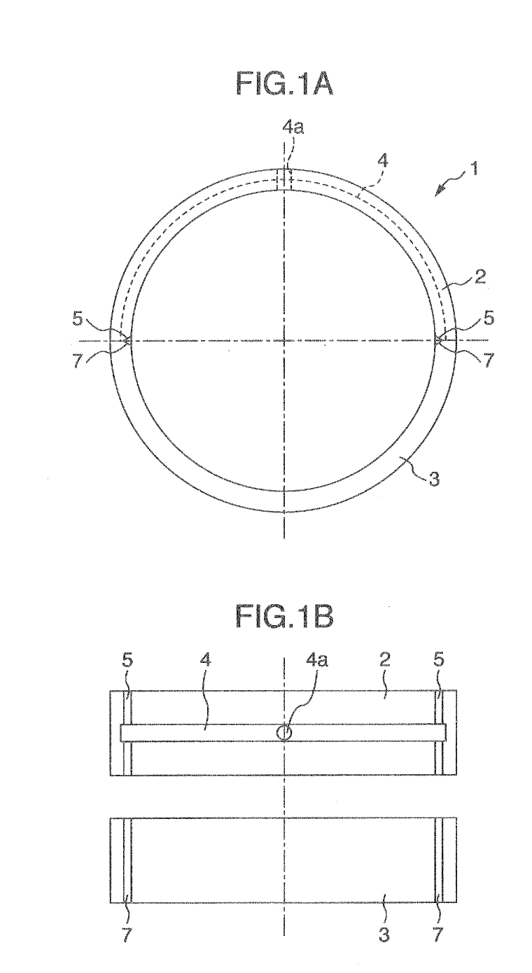

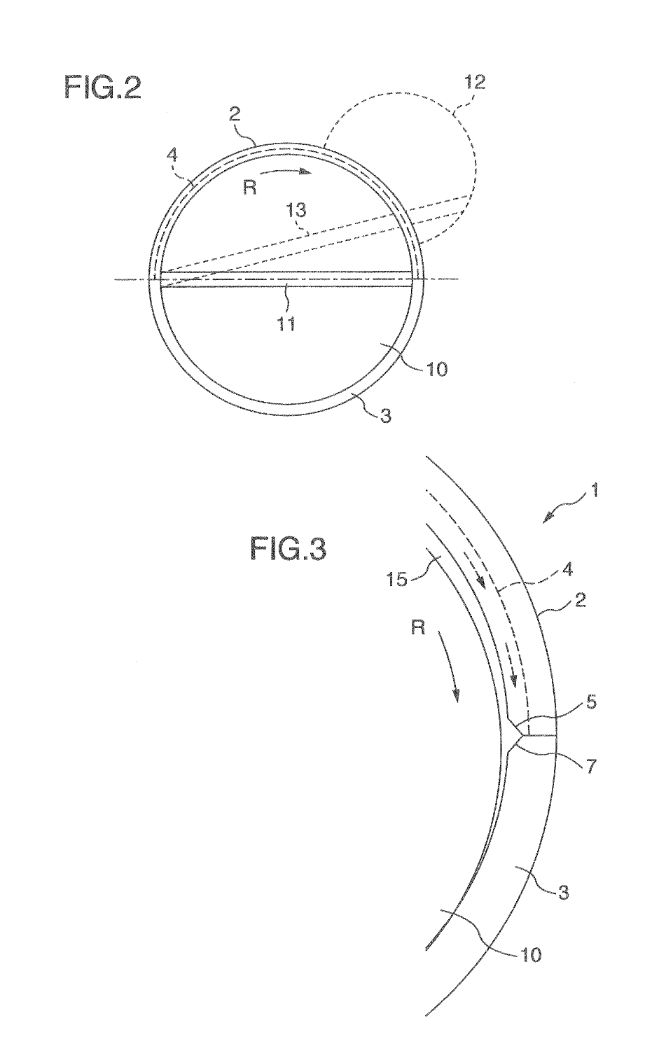

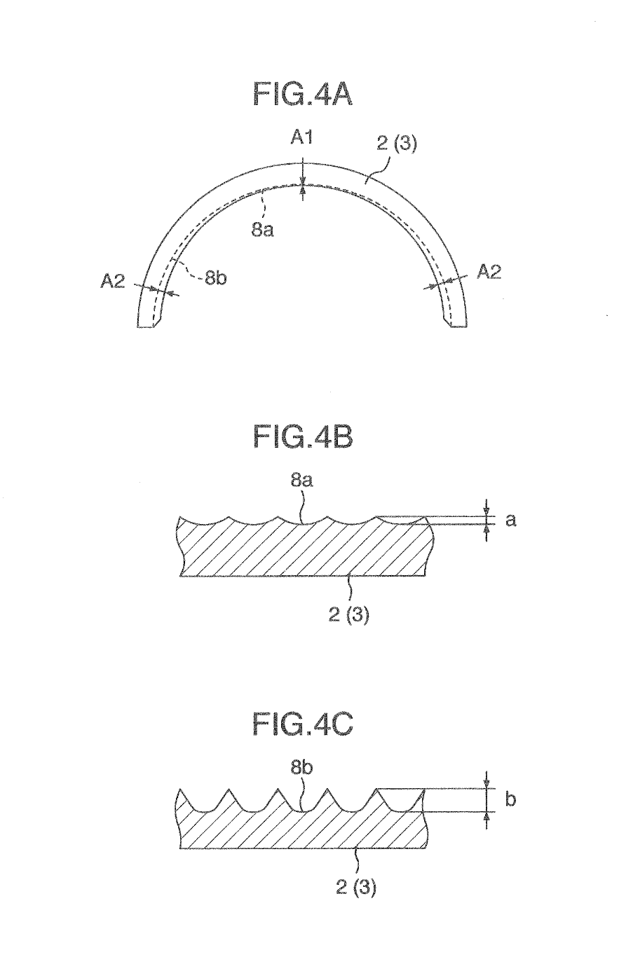

Herein below, referring to FIGS. 1A to 4C, there will be provided a description of embodiments of the invention. FIG. 1A is a side view of a sliding bearing 1 consisting of a pair of an upper half bearing 2 and a lower half bearing 3 which support a crankshaft. FIG. 1B is a inside view of the upper half bearing 2 and the lower half bearing 3. FIG. 2 is a schematic view illustrating a relationship between an axial oil passage 11 formed in a crankshaft 10 and a communicating oil passage 13 leading to a connecting rod pin 12. FIG. 3 is an enlarged view for explaining a foreign-particle discharge mechanism at chamfered portions 5 and 7. FIG. 4A is a side view illustrating a structure of an inner surface of the upper or lower half bearing 2 or 3. FIGS. 4B and 4C are sectional views illustrating the above structure of the upper or lower half bearing 2 or 3.

The sliding bearing 1 for supporting a crankshaft of an internal combustion engine is fabricated cylindrically with a pair of half bearings 2 and 3, as shown in FIG. 1A. Inner surfaces of the half bearings 2 and 3 are formed of a sliding material such as a copper alloy, an aluminum alloy or a tin alloy, for example, in order to make the sliding bearing to satisfy bearing properties, including anti-seizure property, of the half bearings 2 and 3, which sliding material layer is lined on a back steel. An overlay layer of a tin alloy or a synthetic resin may be optionally provided on the sliding material layer.

As shown in FIG. 1B, there is provided an oil groove 4 on an inner surface of the upper half bearing 2 of the both half bearings 2 and 3, which groove 4 is formed so as to circumferentially extend from one circumferential end to the other circumferential end, and in order to supply lubricant oil between the half bearings 2, 3 and a crankshaft 10 (shown in FIGS. 2 and 3) supported by the half bearings 2, 3. The oil groove 4 is formed so as to have a constant depth or a gradually decreasing depth over a predetermined circumferential length range. The oil groove 4 has an oil hole 4a through which oil is supplied from outside.

In the embodiment sliding bearing 1, the inner surfaces of the upper and lower half bearings 2 and 3 are formed so as to have a plurality of circumferential grooves by boring-machining except for the oil groove 4 (see FIGS. 4A to 4C). In the plurality of grooves, those existing in the both circumferential end regions are of deep grooves 8b each having a depth (b) of 5 μm, for example, while the other grooves existing in the central region, which receives load predominantly during rotation of the crankshaft 10, are of shallow grooves 8a each having a depth (a) of 1.5 μm, for example. The deep grooves 8b are subjected to multi-boring machining so as to have a larger cross-sectional area than the shallow grooves 8a. According to the grooves formed by the multi-boring machining, ridges defining the deep grooves 8b in the both circumferential end regions wear in an early operational stage to conform with the crankshaft 10 whereby the thus worn regions serve as crash relieves thereby enabling decrease of an oil leak from the sliding bearing 1 and also of an oil supply quantity to the same.

The upper and lower half bearings 2 and 3 of the embodiment sliding bearing 1 have a unique characteristic of chamfered portions 5 and 7 formed at circumferential inner end edges of the both half bearings (see FIGS. 1A and 1B). The chamfered portions 5 and 7 are formed, respectively, to have the same area as the 0.15 mm to 0.4 mm length chamfer corner area. Each of the chamfered portions 5 and 7 is formed by removing an axially extending corner section of a blank member of each of the half bearings 2 and 3, which corner section has a generally triangular cross sectional form and includes the circumferential inner end edge of the blank half bearing. A circumferential width of the removed generally triangular cross sectional portion is preferably less than 1 mm, more preferably not more than 0.4 mm from the initial circumferential inner end edge which has been already removed. In the embodiment shown in the drawings, although the chamfered portions 5 and 7 are formed at the both inner end edges of the half bearings 2 and 3, the chamfered portions 5 and 7 may be provided at least at a front inner end edge of the upper half bearing 2 with respect to a rotational direction of the crankshaft 10, and at an inner end edge of the lower half bearing 3 adjacent to the above front inner end edge (see the chamfered portions 5 and 7 in the right side of FIGS. 1A and 1B). The chamfered portions 5 and 7 are not always required to be a right-angled isosceles triangular shape, but also they may be a right-angled triangular shape as far as a cutout area has the same area as the 0.15 mm to 0.4 mm length chamfer corner area. The present inventors confirmed that the chamfered portions 5 and 7 having such a right-angled triangular shape well exhibits a foreign particles discharge effect as mentioned below.

When the crankshaft 10 is supported by the sliding bearing 1 fabricated as above, a maximum load is exerted on the lower half bearing 3 in the upper and lower half bearings 2 and 3. With regard to the upper half bearing 2, there exist a clearance 15 between the crankshaft 10 and the upper half bearing 2 (see FIG. 3).

When the crankshaft 10 rotates, there occur oil leaks predominantly through the chamfered portions 5 and 7 at butting faces of the upper and lower half bearings 2 and 3 during rotation of the crankshaft 10, so that the oil near the butting faces flows at a relatively higher rate. Thus, it is possible to discharge foreign particles, which flow in the oil groove 4 (as shown by broken arrow lines in FIG. 3) together with oil supplied from the outside through the hole 4a, to the outside of the sliding bearing 1 through the chamfered portions 5 and 7 (perpendicularly to the page space of FIG. 3). In the case where the chamfered portion 5 or 7 has a cross sectional area smaller than an area of the same as the 0.15 mm length chamfer corner area, it is impossible to obtain an enough effect of discharging the foreign particles and a back surface of the sliding bearing rises in temperature. If the chamfered portion 5 or 7 has an axial cross sectional area exceeding an area of the same as the 0.4 mm length chamfer corner area, there will occur a much amount of oil leaks. Thus, in the embodiment sliding bearing 1, it is possible to smoothly discharge the foreign particles existing within the sliding bearing 1 to the outside without entanglement in the lower half bearing 3 by forming the chamfered portions 5 and 7 at the inner end edges of the upper and lower half bearings 2 and 3.

### Experiment

Specimen sliding bearings of an invention sliding bearing 1 (produced by the multi-boring machining) and a comparative sliding bearing consisting of two half bearings (produced by usual boring machining) were prepared. Each of the half bearings of the comparative sliding bearing was provided with circumferential shallow grooves on an inner surface thereof, crash-relieves at both ends thereof, and chamfered portions at inner end edges thereof.

The specimens were subjected to an experiment for confirming supply oil quantities under the conditions of a bearing load of 40 MPa, a constant oil supply pressure of 0.1 MPa and an oil supply temperature of 80° C.

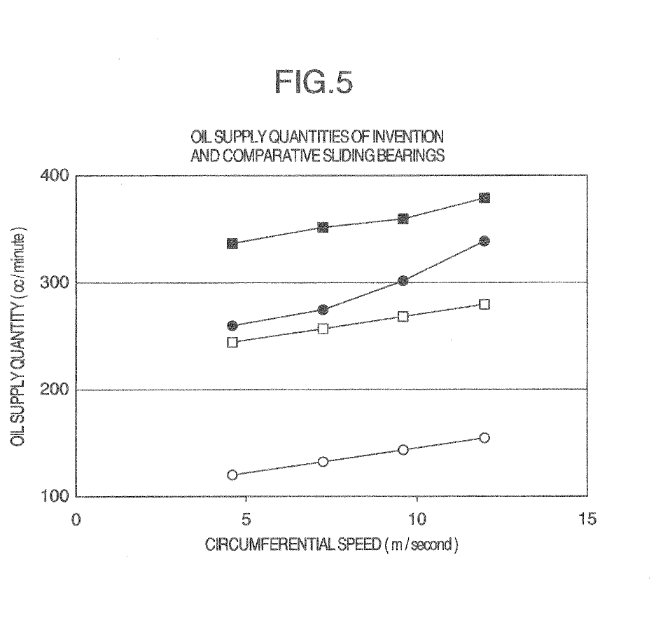

Test results are shown in FIG. 5. In the case of the 0.2 mm length chamfer corner area in any of the comparative specimens (indicated by a line chart with solid circles in FIG. 5) and the invention specimens (indicated by a line chart with white circles in FIG. 5), supply oil quantities to the invention specimens decreased generally half as compared with the comparative specimens at respective circumferential speed. In the case of the 0.4 mm length chamfer corner area in any of the comparative specimens (indicated by a line chart with solid squares in FIG. 5) and the invention specimens (indicated by a line chart with white squares in FIG. 5), supply oil quantities to the invention specimens decreased to 75% as compared with the comparative specimens at respective circumferential speed, and a decrease of the supply oil quantity was noted especially at a high circumferential speed (about 10 m/minute or more) even in comparison with the comparative specimen chamfered with the 0.2 mm length chamfer corner area. Thus, the invention specimens have still the effect of a supply oil reduction in quantity like as usual sliding bearings produced by the multi-boring machining but without chamfered portions, as compared with the comparative specimens. Furthermore, an amount of foreign particles remaining inside the sliding bearing was extremely little. In fact, excellent functions of the chamfered portions 5 and 7 for discharging foreign particles outside the sliding bearing 1 were noted by observing the sliding bearing 1 after being subjected to the experiment. The present inventors also examined a product produced by the multi-boring machining and chamfered with the 0.15 mm length chamfer corner area by the same experiment, and confirmed that a supply oil quantity to the sliding bearing was generally the same as (correctly slightly smaller than) the supply oil quantity of the product produced by the multi-boring machining and chamfered with the 0.2 mm length chamfer corner area, although a back of the sliding bearing rose in a little bit higher temperature.

As will be apparent from the above, according to the embodiment sliding bearing 1, it is possible to advantageously discharge foreign-particles therefrom while preventing oil leaks from the sliding bearing and reducing oil supply quantity to the same.

### LIST OF COMPONENTS

1 a sliding bearing
2 an upper half bearing
3 a lower half bearing
4 an oil groove
4a an oil hole
5 a chamfered portion
7 a chamfered portion
8a shallow grooves
8b deep grooves
10 a crankshaft
11 an axial oil passage
12 a pin of a connecting rod
13 a communicating oil passage
15 a clearance

1. A sliding bearing which is fabricated cylindrically with a pair of upper and lower half bearings so as to support a crankshaft of an internal combustion engine, comprising:
an oil groove is formed circumferentially on an inner surface of at least the upper half bearing,
a plurality of circumferential grooves formed by boring machining on the overall inner surfaces of the half bearings, each of the plurality of circumferential grooves existing in circumferential both end regions having a larger cross-sectional area than the grooves existing in other regions receiving predominantly operational load when the crankshaft rotates, and
wherein the upper half bearing is chamfered at a front inner end edge with respect to a rotational direction of the crankshaft supported by the sliding bearing, and the lower half bearing is also chamfered at an inner end edge adjacent to the above front inner end edge of the upper half bearing, a cross sectional area, perpendicular to the axis of the sliding bearing, of the respective spatial portion formed by the chamfering being the same as a chamfered cross sectional spatial area, perpendicular to the axis of the sliding bearing, of a chamfer corner with a right-angled triangle having an isosceles length of from 0.15 mm to 0.4 mm.

2. A sliding bearing according to claim 1, wherein each of the chamfered portions is formed by removing an axially extending corner section of a blank member of each of the half bearings, which corner section has a generally triangular cross sectional form and includes the circumferential inner end edge of the blank half bearing, and
wherein a circumferential width of the removed generally triangular cross sectional portion is preferably less than 1 mm, more preferably not more than 0.4 mm from the initial circumferential inner end edge which has been already removed.

3. A sliding bearing which is fabricated cylindrically with a pair of upper and lower half bearing so as to support a crankshaft of an internal combustion engine, comprising:
an oil groove is formed circumferentially on an inner surface of at least the upper half bearing, and
a foreign particle discharging groove along at least on of abutting ends of the upper and lower half bearings, the foreign particle discharging groove being formed by chamfering at least an inside corner of the front side abutting end of the upper half bearing with respect to a rotational direction of the crankshaft supported by the sliding bearing, and the foreign particle discharging groove being in fluid communication with the oil groove.

4. A sliding bearing according to claim 3,
wherein the foreign particle discharging groove is formed by chamfering the inside corner of the front side abutting end of the upper half bearing with respect to a rotational direction of the crankshaft supported by the sliding bearing, and another inside corner of another abutting end, adjacent to the former abutting end of the upper half bearing, of the lower half bearing.
